(19) United States
(12) Patent Application Publication
(10) Pub. No.: US 2026/0302245 A1
(43) Pub. Date: Oct. 1, 2026

(54) SECONDARY BATTERY AND ELECTRONIC DEVICE

(71) Applicant: Ningde Amperex Technology Limited, Ningde (CN)

(72) Inventors: Xiaoqian LIU, Ningde (CN); Dongdong HAN, Ningde (CN)

(73) Assignee: Ningde Amperex Technology Limited, Ningde (CN)

(21) Appl. No.: 19/575,931

(22) Filed: Mar. 24, 2026

(30) Foreign Application Priority Data
Mar. 31, 2025 (CN) 202510397489.9

(51) Int. Cl. H01M 4/62; H01M 4/02; H01M 10/0525

(52) U.S. Cl. CPC H01M 4/625; H01M 10/0525; H01M 2004/021; H01M 2004/028

(57) ABSTRACT

A secondary battery includes a positive electrode plate. The positive electrode plate includes a positive electrode current collector and a positive electrode material layer provided on at least one surface of the positive electrode current collector. The positive electrode material layer includes a conductive agent. The conductive agent includes carbon black particles and/or carbon nanotubes. A specific surface area B0 of the conductive agent is 150 m²/g to 1500 m²/g, and an activation energy E0 of the positive electrode plate is 25 kJ/mol to 65 kJ/mol.

### CROSS-REFERENCE TO RELATED APPLICATION

This application claims priority to the Chinese Patent Application Serial No. 202510397489.9, filed on Mar. 31, 2025, the content of which is incorporated herein by reference in its entirety.

### TECHNICAL FIELD

This application relates to the field of electrochemical technologies, and in particular to a secondary battery and an electronic device.

### BACKGROUND

Reducing internal resistance of lithium-ion batteries has always been a pursuit of customers. During a cycling process of lithium-ion batteries, positive electrode impedance dominates. Selecting new conductive agents and building a good conductive network are the main directions for reducing internal resistance of lithium-ion batteries.

In the prior art, internal resistance of a lithium-ion battery is generally reduced by increasing the content of a conductive agent or reducing the content of a binder. However, increasing the content of the conductive agent will lead to a reduction in the content of a positive electrode active material and a reduction in an energy density of the lithium-ion battery. Reducing the content of the binder will lead to a reduction in an adhesion force between a positive electrode material layer and a positive electrode current collector and a reduction in a cohesion of the positive electrode material layer itself, resulting in problems such as film fall-off and thickness swelling during the use of the lithium-ion battery.

### SUMMARY

The purpose of this application is to provide a secondary battery and an electronic device, so as to reduce the internal resistance of the secondary battery. The specific technical solutions are as follows:

A first aspect of this application provides a secondary battery, including a positive electrode plate, where the positive electrode plate includes a positive electrode current collector and a positive electrode material layer provided on at least one surface of the positive electrode current collector, the positive electrode material layer includes a conductive agent, the conductive agent includes carbon black particles and/or carbon nanotubes, a specific surface area B0 of the conductive agent is 150 m²/g to 1500 m²/g, and an activation energy E0 of the positive electrode plate is 25 kJ/mol to 65 kJ/mol. By regulating the type and specific surface area of the conductive agent and the activation energy of the positive electrode plate within the ranges of this application, the internal resistance of the secondary battery can be reduced.

In one embodiment of this application, the specific surface area B0 of the conductive agent is 300 m²/g to 800 m²/g. By regulating the specific surface area of the conductive agent within the above range, the conductive agent has a more appropriate specific surface area, and can provide more adsorption sites for Li+, which is conducive to further reducing the activation energy of the positive electrode plate, thereby further reducing the internal resistance of the secondary battery.

In one embodiment of this application, in a Raman spectrum of the conductive agent, there is a first characteristic peak with a peak intensity of Ip in a range of 1300 cm⁻¹ to 1400 cm⁻¹, and there is a second characteristic peak with a peak intensity of IG in a range of 1550 cm⁻¹ to 1650 cm⁻¹, where 1.0≤I_{D}/I_{G}≤1.5. By regulating the value of I_{D}/I_{G} within the above range, the number of surface defects of the conductive agent is appropriate. On the one hand, this is conducive to desolvation of Li⁺ during the process of passing through the surface of the positive electrode active material and is conducive to reducing the activation energy. On the other hand, the conductive agent also has high conductivity, which can further reduce the internal resistance of the secondary battery.

In one embodiment of this application, an average particle size d1 of the carbon black particles is 5 nm to 50 nm. In one embodiment of this application, the average particle size d1 of the carbon black particles is 10 nm to 40 nm. By regulating the average particle size of the carbon black particles within the above range, the carbon black particles have an appropriate average particle size and the carbon black particles have an appropriate specific surface area, which can provide more adsorption sites for Li⁺, and is conducive to further reducing the activation energy of the positive electrode plate, thereby further reducing the internal resistance of the secondary battery.

In one embodiment of this application, the conductive agent includes the carbon black particles and the carbon nanotubes, and a specific surface area B1 of the carbon black particles is 100 m²/g to 150 m²/g. When the conductive agent includes the carbon black particles and the carbon nanotubes, and the specific surface area of the carbon black particles is regulated within the above range, the conductive agent can have an appropriate specific surface area, and can provide more adsorption sites for Li⁺, which is conducive to further reducing the activation energy of the positive electrode plate, thereby further reducing the internal resistance of the secondary battery.

In one embodiment of this application, a specific surface area B1 of the carbon black particles is 700 m²/g to 1400 m²/g. By regulating the specific surface area of the carbon black particles within the above range, the conductive agent can have a more appropriate specific surface area, and can provide more adsorption sites for Li⁺, which is conducive to further reducing the activation energy of the positive electrode plate, thereby further reducing the internal resistance of the secondary battery.

In one embodiment of this application, in a Raman spectrum of the carbon black particles, there is a third characteristic peak with a peak intensity of ID1 in a range of 1300 cm⁻¹ to 1400 cm⁻¹, and there is a fourth characteristic peak with a peak intensity of I_{G1} in a range of 1550 cm⁻¹ to 1650 cm⁻¹, where 0.8≤I_{D1}/I_{G1}≤1.7. By regulating the value of I_{D1}/I_{G1} within the above range, the number of surface defects of the carbon black particles is appropriate, and the number of surface defects of the conductive agent is appropriate. On the one hand, this is conducive to desolvation of Li⁺ during the process of passing through the surface of the positive electrode active material and is conducive to reducing the activation energy. On the other hand, the conductive agent also has high conductivity, which can further reduce the internal resistance of the secondary battery.

In one embodiment of this application, a diameter d2 of the carbon nanotubes is 3 nm to 15 nm. Regulating the diameter of the carbon nanotubes within the above range allows the positive electrode slurry to have good processing performance, can provide a large effective conductive area, and can further reduce the internal resistance of the secondary battery.

In one embodiment of this application, a specific surface area B2 of the carbon nanotubes is 200 m²/g to 300 m²/g. By regulating the specific surface area of the carbon nanotubes within the above range, the conductive agent can have an appropriate specific surface area, and can provide more adsorption sites for Li⁺, which is conducive to further reducing the activation energy of the positive electrode plate, thereby further reducing the internal resistance of the secondary battery.

In one embodiment of this application, in a Raman spectrum of the carbon nanotubes, there is a fifth characteristic peak with a peak intensity of I_{D2} in a range of 1300 cm⁻¹ to 1400 cm⁻¹, and there is a sixth characteristic peak with a peak intensity of I_{G2} in a range of 1550 cm⁻¹ to 1650 cm⁻¹, where 0.6≤I_{D2}/I_{G2}≤1.3. By regulating the value of I_{D2}/I_{G2} within the above range, the number of surface defects of the carbon nanotubes is appropriate, and the number of surface defects of the conductive agent is appropriate. On the one hand, this is conducive to desolvation of Li⁺ during the process of passing through the surface of the positive electrode active material and is conducive to reducing the activation energy. On the other hand, the conductive agent also has high conductivity, which can further reduce the internal resistance of the secondary battery.

In one embodiment of this application, based on a mass of the positive electrode material layer, a mass percentage W1 of the conductive agent is 0.3% to 3.0%. By regulating the mass percentage of the conductive agent within the above range, the conductive agent has an appropriate mass percentage, which can improve the conductivity of the positive electrode plate, and reduce the internal resistance of the secondary battery.

In one embodiment of this application, the conductive agent includes the carbon black particles and the carbon nanotubes, and based on a mass of the positive electrode material layer, a mass percentage W11 of the carbon black particles is 0.2% to 1.5%, and a mass percentage W12 of the carbon nanotubes is 0 to 1.5%. When the conductive agent includes the carbon black particles and the carbon nanotubes, and the mass percentages of the carbon black particles and the carbon nanotubes are regulated within the above ranges, the carbon black particles and the carbon nanotubes are used in combination, and the carbon black particles and the carbon nanotubes have appropriate mass percentages. This can make the conductive agent have an appropriate mass percentage, can improve the conductivity of the positive electrode plate, and reduce the internal resistance of the secondary battery.

A second aspect of this application provides an electronic device, including the secondary battery according to any one of the foregoing embodiments. Therefore, the electronic device provided by this application has low internal resistance.

Beneficial Effects of this Application:

This application provides the secondary battery and the electronic device. The secondary battery includes the positive electrode plate. The positive electrode plate includes the positive electrode current collector and the positive electrode material layer provided on the at least one surface of the positive electrode current collector. The positive electrode material layer includes the conductive agent. The conductive agent includes the carbon black particles and/or the carbon nanotubes. The specific surface area B0 of the conductive agent is 150 m²/g to 1500 m²/g, and the activation energy E0 of the positive electrode plate is 25 kJ/mol to 65 kJ/mol. By regulating the type and specific surface area of the conductive agent and the activation energy of the positive electrode plate within the ranges of this application, the internal resistance of the secondary battery can be reduced.

Certainly, any product or method implementing this application does not necessarily need to achieve all the advantages described above at the same time.

### DESCRIPTION OF EMBODIMENTS

The technical solutions in this application will be clearly and completely described below in conjunction with the embodiments of this application. Obviously, the described embodiments are only a part of the embodiments of this application, rather than all the embodiments. All other embodiments obtained by those skilled in the art based on this application fall within the protection scope of this application.

It should be noted that in the specific embodiments of this application, lithium-ion batteries are used as examples of secondary batteries to explain this application, but the secondary battery of this application is not limited to lithium-ion batteries.

A first aspect of this application provides a secondary battery, including a positive electrode plate, where the positive electrode plate includes a positive electrode current collector and a positive electrode material layer provided on at least one surface of the positive electrode current collector, the positive electrode material layer includes a conductive agent, the conductive agent includes carbon black particles and/or carbon nanotubes (CNTs), a specific surface area B0 of the conductive agent is 150 m²/g to 1500 m²/g, and an activation energy E0 of the positive electrode plate is 25 kJ/mol to 65 kJ/mol. Exemplarily, the value of B0 can be 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500 or a range defined by any two of the above values. The value of E0 can be 25, 27, 29, 30, 31, 33, 35, 37, 39, 40, 41, 43, 45, 47, 49, 50, 51, 53, 55, 57, 59, 60, 61, 63, 65 or a range defined by any two of the above values. In this application, the carbon black particles include at least one of Super P, acetylene black, or Ketjen black. The carbon nanotubes include single-walled carbon nanotubes and/or multi-walled carbon nanotubes. The above “positive electrode material layer provided on at least one surface of the positive electrode current collector” means that the positive electrode material layer can be provided on one surface of the positive electrode current collector in the thickness direction thereof, or can be provided on two surfaces of the positive electrode current collector in the thickness direction thereof. It should be noted that the “surface” here can be the entire region of the positive electrode current collector or a part of the region of the positive electrode current collector, which is not particularly limited in this application as long as the purpose of this application can be achieved.

In one embodiment of this application, the secondary battery includes a positive electrode plate, the positive electrode plate includes a positive electrode current collector and a positive electrode material layer provided on at least one surface of the positive electrode current collector, the positive electrode material layer includes a conductive agent, the conductive agent includes carbon black particles, a specific surface area B0 of the conductive agent is 150 m²/g to 1500 m²/g, and an activation energy E0 of the positive electrode plate is 25 kJ/mol to 65 kJ/mol.

In one embodiment of this application, the secondary battery includes a positive electrode plate, the positive electrode plate includes a positive electrode current collector and a positive electrode material layer provided on at least one surface of the positive electrode current collector, the positive electrode material layer includes a conductive agent, the conductive agent includes carbon black particles and carbon nanotubes, a specific surface area B0 of the conductive agent is 150 m²/g to 1500 m²/g, and an activation energy E0 of the positive electrode plate is 25 kJ/mol to 65 kJ/mol.

The inventors have found that when the conductive agent in the positive electrode material layer includes the carbon black particles and/or the carbon nanotubes, if the specific surface area of the conductive agent is too large, for example greater than 1500 m²/g, the carbon black particles are not easily dispersed and agglomerate together, affecting the conductive network of the positive electrode material layer. If the specific surface area of the conductive agent is too small, for example less than 150 m²/g, the effective conductive area of the carbon black particles decreases, increasing the internal resistance of the secondary battery. When the specific surface area of the conductive agent is within the range of this application, the conductive agent has an appropriate specific surface area and can provide more adsorption sites for Li⁺, and the positive electrode plate has low activation energy, thereby reducing the internal resistance of the secondary battery.

In one embodiment of this application, the specific surface area B0 of the conductive agent is 300 m²/g to 800 m²/g. Exemplarily, the value of B0 can be 300, 350, 400, 450, 500, 550, 600, 650, 700, 750, 800 or a range defined by any two of the above values. By regulating the specific surface area of the conductive agent within the above range, the conductive agent has a more appropriate specific surface area, and can provide more adsorption sites for Li⁺, which is conducive to further reducing the activation energy of the positive electrode plate, thereby further reducing the internal resistance of the secondary battery.

In one embodiment of this application, in a Raman spectrum of the conductive agent, there is a first characteristic peak with a peak intensity of I_{D} in a range of 1300 cm⁻¹ to 1400 cm⁻¹, and there is a second characteristic peak with a peak intensity of I_{G} in a range of 1550 cm⁻¹ to 1650 cm⁻¹, where 1.0≤I_{D}/I_{G}≤1.5. Exemplarily, the value of I_{D}/I_{G} can be 1.0, 1.05, 1.1, 1.15, 1.2, 1.25, 1.3, 1.35, 1.4, 1.45, 1.5 or a range defined by any two of the above values. The value of I_{D}/I_{G} can indicate the surface defects of the conductive agent. A larger value of Ip/I_{G} means more surface defects of the conductive agent, and easier Li⁺ adsorption by the conductive agent, which is more conducive to desolvation of Li⁺ during the process of passing through the surface of the positive electrode active material, and more conducive to reducing the activation energy. However, too many surface defects of the conductive agent will affect the conductivity of the conductive agent. By regulating the value of I_{D}/I_{G} within the above range, the number of surface defects of the conductive agent is appropriate. On the one hand, this is conducive to desolvation of Li⁺ during the process of passing through the surface of the positive electrode active material and is conducive to reducing the activation energy. On the other hand, the conductive agent also has high conductivity, which can further reduce the internal resistance of the secondary battery.

In one embodiment of this application, an average particle size d1 of the carbon black particles is 5 nm to 50 nm. Exemplarily, the value of d1 can be 5, 7, 10, 15, 17, 20, 25, 27, 30, 35, 37, 40, 45, 47, 50 or a range defined by any two of the above values. In one embodiment of this application, the average particle size d1 of the carbon black particles is 10 nm to 40 nm. By regulating the average particle size of the carbon black particles within the above range, the carbon black particles have an appropriate average particle size and the carbon black particles have an appropriate specific surface area, which can provide more adsorption sites for Li⁺, and is conducive to further reducing the activation energy of the positive electrode plate, thereby further reducing the internal resistance of the secondary battery.

In one embodiment of this application, the conductive agent includes the carbon black particles and the carbon nanotubes, and a specific surface area B1 of the carbon black particles is 100 m²/g to 150 m²/g. Exemplarily, the value of B1 can be 100, 105, 110, 115, 120, 125, 130, 135, 140, 145, 150 or a range defined by any two of the above values. When the conductive agent includes the carbon black particles and the carbon nanotubes, and the specific surface area of the carbon black particles is regulated within the above range, the conductive agent can have an appropriate specific surface area, and can provide more adsorption sites for Li⁺, which is conducive to further reducing the activation energy of the positive electrode plate, thereby further reducing the internal resistance of the secondary battery.

In one embodiment of this application, the conductive agent includes the carbon black particles and the carbon nanotubes, and a specific surface area B1 of the carbon black particles is 150 m²/g to 1500 m²/g. Exemplarily, the value of B1 can be 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500 or a range defined by any two of the above values. In one embodiment of this application, the conductive agent includes carbon black particles and carbon nanotubes, and the specific surface area B1 of the carbon black particles is 700 m²/g to 1400 m²/g. When the conductive agent includes the carbon black particles and the carbon nanotubes, and the specific surface area of the carbon black particles is regulated within the above range, the conductive agent can have an appropriate specific surface area, and can provide more adsorption sites for Li⁺, which is conducive to further reducing the activation energy of the positive electrode plate, thereby further reducing the internal resistance of the secondary battery.

In one embodiment of this application, the conductive agent includes the carbon black particles, and a specific surface area B1 of the carbon black particles is 150 m²/g to 1500 m²/g. Exemplarily, the value of B1 can be 150, 200, 250, 300, 350, 400, 450, 500, 550, 600, 650, 700, 750, 800, 850, 900, 950, 1000, 1050, 1100, 1150, 1200, 1250, 1300, 1350, 1400, 1450, 1500 or a range defined by any two of the above values. When the conductive agent includes the carbon black particles, and the specific surface area of the carbon black particles is regulated within the above range, the conductive agent can have an appropriate specific surface area, and can provide more adsorption sites for Li⁺, which is conducive to reducing the activation energy of the positive electrode plate, thereby reducing the internal resistance of the secondary battery.

In one embodiment of this application, the conductive agent includes the carbon black particles, and a specific surface area B1 of the carbon black particles is 700 m²/g to 1400 m²/g. Exemplarily, the value of B1 can be 700, 750, 800, 850, 900, 950, 1000, 1050, 1100, 1150, 1200, 1250, 1300, 1350, 1400 or a range defined by any two of the above values. When the conductive agent includes the carbon black particles, and the specific surface area of the carbon black particles is regulated within the above range, the conductive agent can have a more appropriate specific surface area, and can provide more adsorption sites for Li⁺, which is conducive to further reducing the activation energy of the positive electrode plate, thereby further reducing the internal resistance of the secondary battery.

In one embodiment of this application, in a Raman spectrum of the carbon black particles, there is a third characteristic peak with a peak intensity of ID1 in a range of 1300 cm⁻¹ to 1400 cm⁻¹, and there is a fourth characteristic peak with a peak intensity of I_{G1} in a range of 1550 cm⁻¹ to 1650 cm⁻¹, where 0.8≤I_{D1}/I_{G1}≤1.7. Exemplarily, the value of I_{D1}/I_{G1} can be 0.8, 0.9, 1.0, 1.1, 1.2, 1.3, 1.4, 1.5, 1.6, 1.7 or a range defined by any two of the above values. The value of I_{D1}/I_{G1} can indicate the surface defects of the carbon black particles. A larger value of I_{D1}/I_{G1} means more surface defects of the carbon black particles, and easier Li⁺ adsorption by the carbon black particles, which is more conducive to desolvation of Li⁺ during the process of passing through the surface of the positive electrode active material, and more conducive to reducing the activation energy. However, too many surface defects of the carbon black particles will affect the conductivity of the carbon black particles. By regulating the value of I_{D1}/I_{G1} within the above range, the number of surface defects of the carbon black particles is appropriate, and the number of surface defects of the conductive agent is appropriate. On the one hand, this is conducive to desolvation of Li⁺ during the process of passing through the surface of the positive electrode active material and is conducive to reducing the activation energy. On the other hand, the conductive agent also has high conductivity, which can further reduce the internal resistance of the secondary battery.

In one embodiment of this application, a diameter d2 of the carbon nanotubes is 3 nm to 15 nm. Exemplarily, the value of d2 can be 3, 4, 5, 6, 7, 8, 9, 10, 11, 12, 13, 14, 15 or a range defined by any two of the above values. Regulating the diameter of the carbon nanotubes within the above range allows the positive electrode slurry to have good processing performance, can provide a large effective conductive area, and can further reduce the internal resistance of the secondary battery.

In one embodiment of this application, the conductive agent includes the carbon black particles and the carbon nanotubes, and a specific surface area B2 of the carbon nanotubes is 200 m²/g to 300 m²/g. Exemplarily, the value of B2 can be 200, 210, 220, 230, 240, 250, 260, 270, 280, 290, 300 or a range defined by any two of the above values. When the conductive agent includes the carbon black particles and the carbon nanotubes, and the specific surface area of the carbon nanotubes is regulated within the above range, the conductive agent can have an appropriate specific surface area, and can provide more adsorption sites for Li⁺, which is conducive to further reducing the activation energy of the positive electrode plate, thereby further reducing the internal resistance of the secondary battery.

In one embodiment of this application, in a Raman spectrum of the carbon nanotubes, there is a fifth characteristic peak with a peak intensity of I_{D2} in a range of 1300 cm⁻¹ to 1400 cm⁻¹, and there is a sixth characteristic peak with a peak intensity of I_{G2} in a range of 1550 cm⁻¹ to 1650 cm⁻¹, where 0.6≤I_{D2}/I_{G2}≤1.3. Exemplarily, the value of I_{D2}/I_{G2} can be 0.6, 0.7, 0.8, 0.9, 1.0, 1.1, 1.2, 1.3 or a range defined by any two of the above values. The value of I_{D2}/I_{G2} can indicate the surface defects of the carbon nanotubes. A larger value of I_{D2}/I_{G2} means more surface defects of the carbon nanotubes, and easier Li⁺ adsorption by the carbon nanotubes, which is more conducive to desolvation of Li⁺ during the process of passing through the surface of the positive electrode active material, and more conducive to reducing the activation energy. However, too many surface defects of the carbon nanotubes will affect the conductivity of the carbon nanotubes. By regulating the value of I_{D2}/I_{G2} within the above range, the number of surface defects of the carbon nanotubes is appropriate, and the number of surface defects of the conductive agent is appropriate. On the one hand, this is conducive to desolvation of Li⁺ during the process of passing through the surface of the positive electrode active material and is conducive to reducing the activation energy. On the other hand, the conductive agent also has high conductivity, which can further reduce the internal resistance of the secondary battery.

In one embodiment of this application, the conductive agent includes the carbon black particles, and based on a mass of the positive electrode material layer, a mass percentage W1 of the conductive agent is 0.3% to 3.0%. Exemplarily, the value of W1 can be 0.3%, 0.5%, 0.7%, 0.9%, 1.0%, 1.1%, 1.3%, 1.5%, 1.7%, 1.9%, 2.0%, 2.1%, 2.3%, 2.5%, 2.7%, 2.9%, 3.0% or a range defined by any two of the above values. When the conductive agent includes the carbon black particles, and the mass percentage of the conductive agent is regulated within the above range, the conductive agent has an appropriate mass percentage, which can improve the conductivity of the positive electrode plate, and reduce the internal resistance of the secondary battery.

In one embodiment of this application, the conductive agent includes carbon black particles and carbon nanotubes, and based on a mass of the positive electrode material layer, a mass percentage W1 of the conductive agent is 0.3% to 3.0%. Exemplarily, the value of W1 can be 0.3%, 0.5%, 0.7%, 0.9%, 1.0%, 1.1%, 1.3%, 1.5%, 1.7%, 1.9%, 2.0%, 2.1%, 2.3%, 2.5%, 2.7%, 2.9%, 3.0% or a range defined by any two of the above values. When the conductive agent includes the carbon black particles and the carbon nanotubes, and the mass percentage of the conductive agent is regulated within the above range, the conductive agent has an appropriate mass percentage, which can improve the conductivity of the positive electrode plate, and reduce the internal resistance of the secondary battery.

In one embodiment of this application, the conductive agent includes carbon black particles and carbon nanotubes, and based on a mass of the positive electrode material layer, a mass percentage W11 of the carbon black particles is 0.2% to 1.5%, and a mass percentage W12 of the carbon nanotubes is 0 to 1.5%. Exemplarily, the value of W11 can be 0.2%, 0.3%, 0.4%, 0.5%, 0.6%, 0.7%, 0.8%, 0.9%, 1.0%, 1.1%, 1.2%, 1.3%, 1.4%, 1.5% or a range defined by any two of the above values. The value of W12 can be 0, 0.1%, 0.2%, 0.3%, 0.4%, 0.5%, 0.6%, 0.7%, 0.8%, 0.9%, 1.0%, 1.1%, 1.2%, 1.3%, 1.4%, 1.5% or a range defined by any two of the above values. When the conductive agent includes the carbon black particles and the carbon nanotubes, and the mass percentages of the carbon black particles and the carbon nanotubes are regulated within the above ranges, the carbon black particles and the carbon nanotubes are used in combination, and the carbon black particles and the carbon nanotubes have appropriate mass percentages. This can make the conductive agent have an appropriate mass percentage, can improve the conductivity of the positive electrode plate, and reduce the internal resistance of the secondary battery.

In one embodiment of this application, under a capacity of 3000 mAh to 4000 mAh, the secondary battery has a 1s direct current impedance (DCR) of 30 mΩ to 60 mΩ at 25° C. and 20% state of charge (SOC), and an internal resistance growth rate R1 of 10% to 60% after 800 cycles at 25° C. The 1s direct current impedance and the internal resistance growth rate after 800 cycles of the secondary battery being within the above ranges indicates that the secondary battery has low internal resistance.

This application has no particular limitation on the preparation method of the carbon black particles, as long as the purpose of this application can be achieved. For example, the preparation method of the carbon black particles can include the following steps: selecting acetylene or tar as a raw material; subjecting the raw material to a high-temperature pyrolysis reaction, where the high-temperature pyrolysis reaction features a temperature of 1000° C. to 1500° C., and time of the high-temperature pyrolysis reaction is 0.1s to 3s, to obtain the carbon black particles; and blowing the above carbon black particles out of a furnace tube, and performing cooling and collecting to obtain the desired carbon black particles.

This application has no particular limitation on the way to regulate the specific surface area of the carbon black particles, as long as the purpose of this application can be achieved. For example, the specific surface area of the carbon black particles can be regulated by regulating the high-temperature pyrolysis reaction time of the carbon black particles. For example, commercially available carbon black particles with different specific surface areas can be selected, and the specific surface area of the carbon black particles can be tested according to the “test method for specific surface area of carbon black particles” in this application, and the carbon black particles with the required specific surface area can be selected.

This application has no particular limitation on the way to regulate the specific surface area of the carbon nanotubes, as long as the purpose of this application can be achieved. For example, the specific surface area of the carbon nanotubes can be regulated by regulating the diameter of the carbon nanotubes. For example, commercially available carbon nanotubes with different specific surface areas can be selected, and the specific surface area of the carbon nanotubes can be tested according to the “test method for specific surface area of carbon nanotubes” in this application, and the carbon nanotubes with the required specific surface area can be selected.

This application has no particular limitation on the way to regulate the specific surface area of the conductive agent, as long as the purpose of this application can be achieved. For example, when the conductive agent includes carbon black particles, the specific surface area of the conductive agent can be regulated by regulating the specific surface area of the carbon black particles, and the regulation method of the specific surface area of the carbon black particles is as described above. When the conductive agent includes carbon black particles and carbon nanotubes, the specific surface area of the conductive agent can be regulated by regulating the respective specific surface areas of the carbon black particles and the carbon nanotubes, and the regulation method of the specific surface area of the carbon black particles and the carbon nanotubes is as described above.

This application has no particular limitation on the way to regulate the value of I_{D1}/I_{G1} of the carbon black particles, as long as the purpose of this application can be achieved. For example, the value of I_{D1}/I_{G1} of the carbon black particles can be regulated by regulating the high-temperature pyrolysis reaction time.

This application has no particular limitation on the way to regulate the value of I_{D2}/I_{G2} of the carbon nanotubes, as long as the purpose of this application can be achieved. For example, the value of I_{D2}/I_{G2} of the carbon nanotubes can be regulated by regulating the synthesis temperature of the carbon nanotubes.

This application has no particular limitation on the way to regulate the value of I_{D}/I_{G} of the conductive agent, as long as the purpose of this application can be achieved. For example, when the conductive agent includes carbon black particles, the value of I_{D}/I_{G} of the conductive agent can be regulated by regulating the high-temperature pyrolysis reaction time of the carbon black particles to regulate the value of I_{D1}/I_{G1} of the carbon black particles. When the conductive agent includes carbon black particles and carbon nanotubes, the value of I_{D}/I_{G} of the conductive agent can be regulated by regulating the value of I_{D1}/I_{G1} of the carbon black particles and the value of I_{D2}/I_{G2} of the carbon nanotubes, and the regulation methods of the value of I_{D1}/I_{G1} of the carbon black particles and the value of I_{D2}/I_{G2} of the carbon nanotubes are as described above.

This application has no particular limitation on the way to regulate the activation energy of the positive electrode plate, as long as the purpose of this application can be achieved. For example, when the conductive agent includes carbon black particles, the activation energy of the positive electrode plate can be regulated by regulating the specific surface area of the carbon black particles. When the conductive agent includes carbon black particles and carbon nanotubes, the activation energy of the positive electrode plate can be regulated by regulating the respective contents of the carbon black particles and the carbon nanotubes.

This application has no particular limitation on the way to regulate the average particle size of the carbon black particles, as long as the purpose of this application can be achieved. For example, the average particle size of the carbon black particles can be regulated by regulating the high-temperature pyrolysis reaction time. For example, commercially available carbon black particles with different average particle sizes can be selected.

This application has no particular limitation on the way to regulate the diameter of the carbon nanotubes, as long as the purpose of this application can be achieved. For example, the diameter of the carbon nanotubes can be regulated by regulating the synthesis temperature of the carbon nanotubes. For example, commercially available carbon nanotubes with different diameters can be selected.

This application has no particular limitation on the way to regulate the mass percentage of the conductive agent, as long as the purpose of this application can be achieved. For example, the mass percentage of the conductive agent can be regulated by regulating the mass of the added conductive agent.

This application has no particular limitation on the way to regulate the mass percentage of the carbon black particles and the mass percentage of the carbon nanotubes, as long as the purpose of this application can be achieved. For example, the mass percentage of the carbon black particles can be regulated by regulating the mass of the added carbon black particles, and the mass percentage of the carbon nanotubes can be regulated by regulating the mass of the added carbon nanotubes.

This application has no particular limitation on the positive electrode current collector, as long as the purpose of this application can be achieved. For example, it can include aluminum foil, aluminum alloy foil, composite current collector (such as aluminum-carbon composite current collector), or the like.

In this application, the positive electrode material layer further includes a positive electrode active material. This application has no particular limitation on the positive electrode active material, as long as the purpose of this application can be achieved. For example, the positive electrode active material can include but is not limited to at least one of lithium cobalt oxide (LiCoO₂), lithium manganate, lithium nickelate, lithium nickel cobalt manganate, lithium nickel cobalt aluminate, lithium iron phosphate, lithium manganese iron phosphate, lithium vanadium phosphate, lithium-rich manganese-based material, or lithium titanate. The above lithium nickel cobalt manganate can include at least one of LiNi_{0.95}Co_{0.03}Mn_{0.02}O₂ (Ni95), LiNi_{0.91}Co_{0.03}Mn_{0.06}O₂ (Ni91), LiNi_{0.8}Co_{0.1}Mn_{0.1}O₂ (NCM811), LiNi_{0.6}Co_{0.2}Mn_{0.2}O₂ (NCM622), LiNi_{0.5}Co_{0.2}Mn_{0.3}O₂ (NCM523), or LiNi_{1/3}Co_{1/3}Mn_{1/3}O₂ (NCM111). The positive electrode material layer of this application further includes a positive electrode binder. This application has no particular limitation on the positive electrode binder, as long as the purpose of this application can be achieved. For example, the positive electrode binder can include but is not limited to at least one of polyvinylidene fluoride (PVDF), a copolymer of vinylidene fluoride-hexafluoropropylene, polyacrylonitrile, polyacrylate, polyacrylic acid, polyacrylate salt, polyvinylpyrrolidone, polyamide, polyvinyl ether, polymethyl methacrylate, polytetrafluoroethylene, polyhexafluoropropylene, styrene-butadiene rubber (SBR), polypropylene, polyethylene, polyetherimide, a copolymer of olefin derivatives, or carboxymethyl cellulose salt. The above carboxymethyl cellulose salt can include but is not limited to at least one of sodium carboxymethyl cellulose, potassium carboxymethyl cellulose, or lithium carboxymethyl cellulose. This application has no particular limitation on the mass percentage of the positive electrode active material and the positive electrode binder in the positive electrode material layer, which can be selected by those skilled in the art according to actual needs, as long as the purpose of this application can be achieved. For example, based on the mass of the positive electrode material layer, the mass percentage W2 of the positive electrode active material is 94% to 99.2%, and the mass percentage W3 of the positive electrode binder is 0.5% to 3.0%.

This application has no particular limitation on the thickness of the positive electrode current collector, as long as the purpose of this application can be achieved. For example, the thickness of the positive electrode current collector is 6 μm to 16 μm. This application has no particular limitation on the thickness of the positive electrode material layer, as long as the purpose of this application can be achieved. For example, the thickness of the positive electrode material layer on one surface is 25 μm to 250 μm.

Optionally, the positive electrode plate can also include a conductive layer, and the conductive layer is located between the positive electrode current collector and the positive electrode material layer. This application has no particular limitation on the composition of the conductive layer, which can be a conductive layer commonly used in the art. The conductive layer includes a conductive agent and a binder. This application has no particular limitation on the conductive agent and the binder in the conductive layer, which can be at least one of the above conductive agent and the above positive electrode binder. This application has no particular limitation on the mass ratio of the conductive agent and the binder in the conductive layer, which can be selected by those skilled in the art according to actual needs, as long as the purpose of this application can be achieved.

In this application, the secondary battery further includes a negative electrode plate. The negative electrode plate includes a negative electrode current collector and a negative electrode material layer provided on at least one surface of the negative electrode current collector. The above “negative electrode material layer provided on at least one surface of the negative electrode current collector” means that the negative electrode material layer can be provided on one surface of the negative electrode current collector in the thickness direction thereof, or can be provided on two surfaces of the negative electrode current collector in the thickness direction thereof. It should be noted that the “surface” here can be the entire region of the negative electrode current collector or a part of the region of the negative electrode current collector, which is not particularly limited in this application as long as the purpose of this application can be achieved. This application has no particular limitation on the negative electrode current collector, as long as the purpose of this application can be achieved. For example, it can include copper foil, copper alloy foil, nickel foil, stainless steel foil, titanium foil, foamed nickel, foamed copper, composite current collector, or the like.

The negative electrode material layer of this application includes a negative electrode active material. This application has no particular limitation on the negative electrode active material, as long as the purpose of this application can be achieved. For example, the negative electrode active material can include at least one of natural graphite, artificial graphite, mesocarbon microbeads (MCMB), hard carbon, soft carbon, silicon, silicon-carbon composite, SiOₓ (0.5<x<1.6), Li—Sn alloy, Li—Sn—O alloy, Sn, SnO, SnO₂, spinel-structured lithiated titanate Li₄Ti₅O₁₂, Li—Al alloy, or metallic lithium. The negative electrode material layer of this application further includes a negative electrode binder and a negative electrode conductive agent. This application has no particular limitation on the negative electrode binder and the negative electrode conductive agent in the negative electrode material layer, as long as the purpose of this application can be achieved. For example, the negative electrode binder can be at least one of the above negative electrode binder, and the negative electrode conductive agent can be at least one of the above conductive agent. This application has no particular limitation on the mass ratio of the negative electrode active material, the negative electrode binder, and the negative electrode conductive agent in the negative electrode material layer, which can be selected by those skilled in the art according to actual needs, as long as the purpose of this application can be achieved.

This application has no particular limitation on the thickness of the negative electrode current collector, as long as the purpose of this application can be achieved. For example, the thickness of the negative electrode current collector is 4 μm to 12 μm. This application has no particular limitation on the thickness of the negative electrode material layer, as long as the purpose of this application can be achieved. For example, the thickness of the negative electrode material layer on one surface is 30 μm to 250 μm.

Optionally, the negative electrode plate can further include a conductive layer, and the conductive layer is located between the negative electrode current collector and the negative electrode material layer. This application has no particular limitation on the composition of the conductive layer, which can be a conductive layer commonly used in the art. The conductive layer includes a conductive agent and a binder. This application has no particular limitation on the conductive agent and the binder in the conductive layer, which can be at least one of the above negative electrode conductive agent and the above negative electrode binder. This application has no particular limitation on the mass ratio of the conductive agent and the binder in the conductive layer, which can be selected by those skilled in the art according to actual needs, as long as the purpose of this application can be achieved.

In this application, the secondary battery further includes an electrolyte. The electrolyte includes a lithium salt and a non-aqueous solvent. The lithium salt can include various lithium salts commonly used in the art, such as at least one of LiPF₆, LiBF₄, LiAsF₆, LiCIO₄, LiB(C₆H₅)₄, LiCH₃SO₃, LiCF₃SO₃, LiN(SO₂CF₃)₂, LiC(SO₂CF₃)₃, Li₂SiF₆, lithium bis(oxalate)borate (LiBOB), or lithium difluoroborate. This application has no particular limitation on the non-aqueous solvent, as long as the purpose of this application can be achieved. For example, it can include but is not limited to at least one of carbonate compound, carboxylate compound, ether compound, or other organic solvents. The above carbonate compound can include but is not limited to at least one of chain carbonate compound, cyclic carbonate compound, or fluorinated carbonate compound. The above chain carbonate compound can include but is not limited to at least one of dimethyl carbonate (DMC), diethyl carbonate (DEC), dipropyl carbonate (DPC), methyl propyl carbonate (MPC), ethyl propyl carbonate (EPC), or methyl ethyl carbonate (EMC). The above cyclic carbonate compound can include but is not limited to at least one of ethylene carbonate (EC), propylene carbonate (PC), butylene carbonate (BC), or vinylethylene carbonate (VEC). The above fluorinated carbonate compound can include but is not limited to at least one of fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, or trifluoromethylethylene carbonate. The above carboxylate compound can include but is not limited to at least one of methyl formate, methyl acetate, ethyl acetate, n-propyl acetate, tert-butyl acetate, methyl propionate, ethyl propionate, propyl propionate, γ-butyrolactone, decanolactone, valerolactone, or caprolactone. The above ether compound can include but is not limited to at least one of dibutyl ether, tetraglyme, diglyme, 1,2-dimethoxyethane, 1,2-diethoxyethane, 1-ethoxy-1-methoxyethane, 2-methyltetrahydrofuran, or tetrahydrofuran. The other organic solvents can include but are not limited to at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate. This application has no particular limitation on the mass percentages of the lithium salt and the non-aqueous solvent, as long as the purpose of this application can be achieved.

In this application, the secondary battery further includes a separator. The separator is used to separate the positive electrode plate and the negative electrode plate, prevent internal short circuit of the secondary battery, allow electrolyte ions to pass freely, and does not affect the electrochemical charge and discharge process. This application has no particular limitation on the separator, as long as the purpose of this application can be achieved. For example, the material of the separator can include but is not limited to at least one of polyethylene (PE), polypropylene (PP)-based polyolefin (PO), polyester (such as polyethylene terephthalate (PET) film), cellulose, polyimide (PI), polyamide (PA), spandex, or aramid; the type of the separator can include at least one of woven film, non-woven film, microporous film, composite film, calendered film, or spun film.

In this application, the separator can include a base film and a surface treatment layer. The base film can be a non-woven fabric or composite film with a porous structure, and the material of the base film can include at least one of polyethylene, polypropylene, polyethylene terephthalate, or polyimide. Optionally, a polypropylene porous film, a polyethylene porous film, a polypropylene non-woven fabric, a polyethylene non-woven fabric, or a polypropylene-polyethylene-polypropylene porous composite film can be used. Optionally, the surface treatment layer is provided on at least one surface of the base film, and the surface treatment layer can be a polymer layer or an inorganic layer, or a layer formed by mixing polymer and inorganic substance. For example, the inorganic layer includes inorganic particles and a binder for separator. This application has no particular limitation on the above inorganic particles, which for example can include at least one of alumina, silica, magnesia, titania, hafnia, tin oxide, ceria, nickel oxide, zinc oxide, calcium oxide, zirconia, yttria, silicon carbide, boehmite, aluminum hydroxide, magnesium hydroxide, calcium hydroxide, or barium sulfate. This application has no particular limitation on the above binder for separator, for example, which can be at least one of the foregoing positive electrode binder. The polymer layer includes a polymer, and the material of the polymer includes at least one of polyamide, polyacrylonitrile, acrylate polymer, polyacrylic acid, polyvinylpyrrolidone, polyvinyl ether, polyvinylidene fluoride, or poly(vinylidene fluoride-hexafluoropropylene).

The secondary battery of this application further includes a packaging bag for accommodating the positive electrode plate, the separator, the negative electrode plate, and the electrolyte, as well as other components known in the art in the secondary battery. This application does not limit the above other components. This application has no particular limitation on the packaging bag, which can be a packaging bag known in the art, as long as the purpose of this application can be achieved.

This application has no particular limitation on the type of the secondary battery, which can include any device that undergoes an electrochemical reaction. In this application, the secondary battery can include but is not limited to: lithium metal secondary battery, lithium-ion secondary battery (lithium-ion battery), lithium polymer secondary battery, lithium-ion polymer secondary battery, or the like.

The preparation process of the secondary battery of this application is well known to those skilled in the art, and this application has no particular limitation. For example, it can include but is not limited to the following steps: stacking the positive electrode plate, the separator, and the negative electrode plate in order, performing winding or folding as needed to obtain an electrode assembly with a wound structure, placing the electrode assembly in a packaging bag, and injecting the electrolyte into the packaging bag and performing sealing to obtain a secondary battery; or laminating the positive electrode plate, the separator, and the negative electrode plate in order, fixing the four corners of the entire laminated structure with tape to obtain an electrode assembly with a laminated structure, placing the electrode assembly in a packaging bag, and injecting the electrolyte into the packaging bag and performing sealing to obtain a secondary battery. In addition, an overcurrent prevention element, a guide plate, or the like can be placed in the packaging bag as needed to prevent pressure rise, overcharge, and overdischarge inside the secondary battery. The packaging bag is a packaging bag known in the art, and this application does not limit it.

A second aspect of this application provides an electronic device, including the secondary battery according to any one of the foregoing embodiments. Therefore, the electronic device provided by this application has low internal resistance.

This application has no particular limitation on the type of the electronic device, which can be any electronic device known in the prior art. In some embodiments, the electronic device can include but is not limited to: notebook computer, pen input computer, mobile computer, e-book player, portable telephone, portable fax machine, portable copier, portable printer, stereo headset, video recorder, LCD TV, portable cleaner, portable CD player, mini disc, transceiver, electronic notebook, calculator, memory card, portable recorder, radio, backup power supply, motor, automobile, motorcycle, electric bicycle, bicycle, lighting fixture, toy, game console, clock, power tool, flash lamp, camera, large household battery, lithium ion capacitor, or the like.

### EXAMPLES

Hereinafter, examples and comparative examples are given to explain the embodiments of this application more specifically. Various tests and evaluations are performed according to the following methods. In addition, unless otherwise specified, “parts” and “%” are on a mass basis.

### Test Methods and Equipment:

### Sampling Method for Conductive Agent:

(1) A lithium-ion battery was disassembled to obtain a positive electrode plate. (2) The above positive electrode plate was soaked in N-methylpyrrolidone (NMP) for film removing, a positive electrode material layer film was dissolved in a solvent, and a disperser was used to mix the foregoing substances to uniformity to obtain a slurry. (3) The above slurry was taken, and a positive electrode binder in the slurry was separated by centrifugation to obtain a slurry containing a positive electrode active material and a conductive agent. (4) The positive electrode active material (lithium cobalt oxide or lithium nickel cobalt manganate) in the slurry containing the positive electrode active material and the conductive agent was digested with hydrochloric acid, where a lithium iron phosphate-based positive electrode active material was digested with hydrochloric acid-hydrogen peroxide, followed by drying to obtain the conductive agent. The conductive agents used in the subsequent test for specific surface area of conductive agent and Raman spectrum test for conductive agent were all sampled by the above method.

### Test for Specific Surface Area of Conductive Agent:

According to the national standard “Determination of specific surface area of solid materials by gas adsorption bet method” (GB/T 19587-2017), a specific surface area analyzer (model: TristarII 3020M) was used, and the specific surface area of the above conductive agent was tested by the gas adsorption method.

### Raman Spectrum Test of Conductive Agent:

A laser micro-confocal Raman spectrometer (model: HR Evolution, by HORIBA Scientific) was used to test the Raman spectrum of the above conductive agent. The peak intensity of the conductive agent at 1350 cm⁻¹ was Ip, and the peak intensity at 1580 cm⁻¹ was I_{G}. The value of I_{D}/I_{G} of the conductive agent was obtained in the following manner: the above conductive agent powder was placed on a Raman test sample stage, the Raman spectrum of the conductive agent powder was tested to obtain the value of I_{D}/I_{G}, the test was performed 12 times, and the average value was taken as the I_{D}/I_{G} value of the conductive agent.

### Raman Spectrum Test for Carbon Black Particles:

A laser micro-confocal Raman spectrometer (model: HR Evolution, by HORIBA Scientific) was used to test the Raman spectrum of the carbon black particles. The peak intensity of the carbon black particles at 1350 cm⁻¹ was I_{D1}, and the peak intensity at 1580 cm⁻¹ was I_{G1}. The value of I_{D1}/I_{G1} of the carbon black particles was obtained in the following manner: the above carbon black particles were placed on a Raman test sample stage, the Raman spectrum of the carbon black particles was tested to obtain the value of I_{D1}/I_{G1}, the test was performed 12 times, and the average value was taken as the I_{D1}/I_{G1} value of the carbon black particles.

### Raman Spectrum Test for Carbon Nanotubes:

A laser micro-confocal Raman spectrometer (model: HR Evolution, by HORIBA Scientific) was used to test the Raman spectrum of the carbon nanotubes. The peak intensity of the carbon nanotubes at 1350 cm⁻¹ was I_{D2}, and the peak intensity at 1580 cm⁻¹ was I_{G2}. The value of I_{D2}/I_{G2} of the carbon nanotubes was obtained in the following manner: the above carbon nanotubes were placed on a Raman test sample stage, the Raman spectrum of the carbon nanotubes was tested to obtain the value of I_{D2}/I_{G2}, the test was performed 12 times, and the average value was taken as the I_{D2}/I_{G2} value of the carbon nanotubes.

### Activation Energy Test for Positive Electrode Plate:

(1) A lithium-ion battery was taken, and a post-reference electrode was inserted to make a three-electrode battery.

(2) The above three-electrode battery was taken, the temperature T was set to (273±2) K, (283±2) K, (298±2) K, and (308±2) K, and electrochemical impedance spectroscopy (EIS) scanning was performed to obtain Rct at the corresponding temperature.

(3) The activation energy of the positive electrode plate was calculated according to the Arrhenius equation (Arrhenius equation) k=Aexp(−Ea/RT): a scatter plot was established with ln Rct as the ordinate and 1000/T as the abscissa, the corresponding temperature T and Rct in step (2) were substituted to obtain 4 points, the linear equation of the above 4 points was fitted, and the slope of the linear equation multiplied by the gas constant R (8.314 J·mol⁻¹·K⁻¹) was taken as the activation energy E0 of the positive electrode plate.

### Test for Average Particle Size of Carbon Black Particles and Diameter of Carbon Nanotubes:

(1) A lithium-ion battery was disassembled to obtain a positive electrode plate. (2) The above positive electrode plate was soaked in dimethyl carbonate (DMC) at room temperature for 60 min, taken out, and dried at room temperature. (3) The positive electrode plate obtained in step (2) was taken, and a cross section of a positive electrode material layer on the positive electrode plate was obtained by liquid nitrogen brittle fracture. (4) The above cross section was observed by a scanning electron microscope (SEM, model: Thermo Fisher FEI-Apreo S), particle sizes of no less than 50 carbon black particles and diameters of no less than 30 carbon nanotubes were tested in total in 10 regions, and the average value was taken as the average particle size of the carbon black particles and the diameter of the carbon nanotubes.

### Test for Specific Surface Area of Carbon Black Particles:

According to the national standard “Determination of specific surface area of solid materials by gas adsorption bet method” (GB/T 19587-2017), a specific surface area analyzer (model: TristarII 3020M) was used, and the specific surface area of the carbon black particles was tested by the gas adsorption method.

### Test for Specific Surface Area of Carbon Nanotubes:

According to the national standard “Determination of specific surface area of solid materials by gas adsorption bet method” (GB/T 19587-2017), a specific surface area analyzer (model: TristarII 3020M) was used, and the specific surface area of the carbon nanotubes was tested by the gas adsorption method.

### Test for 1s Direct Current Impedance (DCR):

The lithium-ion battery in the example or comparative example was taken, and the following test was performed at 25=2° C. (1) It was left standing for 2 h. (2) Then it was charged at a constant current of 1.0C to 4.50 V, and charged at a constant voltage of 4.50 V until the current was less than or equal to 0.025C; and left standing for 2 h. (3) Then it was discharged at a constant current of 0.2C to 3.0 V, where the discharge capacity of this step was taken as C1, and left standing for 5 h. (4) Then it was charged at a constant current of 1.0C1 to 4.50 V, and charged at a constant voltage of 4.50 V until the current was less than or equal to 0.025C1; and left standing for 10 min. (5) Then it was discharged at a constant current of 0.1C1 until the capacity was 0.2C1, left standing for 15 min, where the voltage at this time was recorded as V₀, and then discharged at a constant current of 1.0C1 for 1s, where the voltage at this time was recorded as V₁. The 1s DCR at 25° C. 20% SOC was (V₀−V₁)/1.0C1.

Test for Internal Resistance Growth Rate after 800 Cycles at 25° C.:

The lithium-ion battery in the example or comparative example was taken, and the following test was performed at 25±2° C.

(1) It was left standing for 2 h, discharged at a constant current of 0.7C to 3.0 V, and left standing for 5 min.

(2) It was charged at a constant current of 1.0C to 4.50 V, charged at a constant voltage of 4.50 V until the current was less than or equal to 0.05C, left standing for 5 min, discharged at a constant current of 0.5C to 3.0 V, where the internal resistance of the lithium-ion battery at this time was tested with 1000 Hz sinusoidal current and recorded as IMP1, and left standing for 5 min. The above steps were repeated for 49 cycles, and the internal resistance of the lithium-ion battery was recorded as IMP1, IMP2, . . . , IMP49 in sequence. Then the 50th cycle was performed. In the 50th cycle, it was charged at a constant current of 1.0C to 4.50 V, charged at a constant voltage of 4.50 V until the current was less than or equal to 0.05C, left standing for 5 min, and discharged at a constant current of 0.2C to 3.0 V, were the internal resistance of the lithium-ion battery at this time was IMP50.

(3) Then the above step (2) was repeated for 16 times. Then it was charged at a constant current of 1.0C to 4.50 V, charged at a constant voltage of 4.50 V until the current was less than or equal to 0.05C, left standing for 5 min, and discharged at a constant current of 0.5C to 3.0 V, where the internal resistance of the lithium-ion battery in the 801st cycle was recorded as IMP801. Internal resistance growth rate R1(%) of lithium-ion battery after 800 cycles at 25° C.=IMP801/IMP1-100%.

### Example 1-1

### <Preparation of Positive Electrode Plate>

Lithium cobalt oxide (LiCoO₂) as a positive electrode active material, carbon black particles as a conductive agent, carbon nanotubes as a conductive agent, and polyvinylidene fluoride (PVDF) as a positive electrode binder were mixed in a weight ratio of 97.6:0.3:0.6:1.5, and N-methylpyrrolidone (NMP) as a solvent was added. These substances were stirred and mixed uniformly to obtain a positive electrode slurry, where the solid content of the positive electrode slurry was 70 wt %. The carbon black particles were acetylene black, and the carbon nanotubes were multi-walled carbon nanotubes. The positive electrode slurry was uniformly applied on one surface of a positive electrode current collector aluminum foil with a thickness of 12 μm, and dried at 120° C. for 1 h to obtain a positive electrode plate with a positive electrode material layer with a thickness of 100 μm applied on one surface. The above steps were repeated on the other surface of the aluminum foil to obtain a positive electrode plate with positive electrode material layers applied on two surfaces. It was dried under vacuum at 120° C. for 1 h, and then cold-pressed, cut, and slit to obtain a positive electrode plate with specifications of 74 mm×867 mm. A compacted density of the cold pressing process was 4.2 g/cm³.

### <Preparation of Negative Electrode Plate>

Artificial graphite as a negative electrode active material, sodium carboxymethyl cellulose (CMC-Na) as a negative electrode binder, and styrene-butadiene rubber (SBR) as a negative electrode binder were mixed in a weight ratio of 95:2:3, and deionized water as a solvent was added. These substances were stirred and mixed uniformly to obtain a negative electrode slurry, where the solid content of the negative electrode slurry was 75 wt %. The negative electrode slurry was uniformly applied on one surface of a negative electrode current collector copper foil with a thickness of 12 μm, and dried at 120° C. to obtain a negative electrode plate with a negative electrode material layer with a thickness of 120 μm applied on one surface. The above steps were repeated on the other surface of the copper foil to obtain a negative electrode plate with negative electrode material layers applied on two surfaces. It was dried under vacuum at 120° C. for 1 h, and then cold-pressed, cut, and slit to obtain a negative electrode plate with specifications of 78 mm×875 mm. A compacted density of the cold pressing process was 1.75 g/cm³.

### <Preparation of Electrolyte>

In an argon atmosphere glove box with water content less than 10 ppm, ethylene carbonate (EC), dimethyl carbonate (DMC), and methyl ethyl carbonate (EMC) were mixed in a weight ratio of 1:1:1 to obtain a base solvent, and then a lithium salt lithium hexafluorophosphate (LiPF₆) was added. These substances were mixed uniformly to obtain an electrolyte. Based on the mass of the electrolyte, the mass percentage of the lithium salt was 12.5%, and the balance was for the base solvent.

### <Preparation of Separator>

A polyethylene (PE) film with a thickness of 15 μm was used.

### <Preparation of Lithium-Ion Battery>

The positive electrode plate, the separator, the negative electrode plate, and the separator prepared above were stacked in order, with the separator in the middle between the positive electrode plate and the negative electrode plate for separation, and wound to obtain an electrode assembly. After tabs were welded, the electrode assembly was placed in an aluminum-plastic film packaging bag and dried, the electrolyte was injected, and then vacuum sealing, standing, formation, degassing, and slitting processes were carried out to obtain a lithium-ion battery.

### Examples 1-2 to 1-6

Except that the average particle size and specific surface area of the carbon black particles were made as shown in Table 1 by adjusting the high-temperature pyrolysis reaction time of the carbon black particles, the rest was the same as Example 1-1.

### Examples 1-7 to 1-11

Except that the value of I_{D1}/I_{G1} of the carbon black particles was made as shown in Table 1 by adjusting the high-temperature pyrolysis reaction time of the carbon black particles, the rest was the same as Example 1-3.

### Examples 1-12 to 1-15

Except that the diameter and specific surface area of the carbon nanotubes were made as shown in Table 1 by adjusting the synthesis temperature of the carbon nanotubes, the rest was the same as Example 1-3.

### Examples 1-16 to 1-18

Except that the value of I_{D2}/I_{G2} of the carbon nanotubes were made as shown in Table 1 by adjusting the synthesis temperature of the carbon nanotubes, the rest was the same as Example 1-3.

### Examples 2-1 to 2-11

Except that the relevant preparation parameters were adjusted according to Table 2, the rest was the same as Example 1-3.

### Comparative Examples 1-1 to 1-4

Except that the relevant preparation parameters were adjusted according to Table 1, the rest was the same as Example 1-3.

### Comparative Example 1-5

Except that in <preparation of positive electrode plate>, lithium cobalt oxide (LiCoO₂) as a positive electrode active material, graphene as a conductive agent, and polyvinylidene fluoride (PVDF) as a positive electrode binder were mixed in a weight ratio of 97.6:0.9:1.5, NMP was added as a solvent, and these substances were stirred and mixed uniformly to obtain a positive electrode slurry, the rest was the same as Example 1-3.

### Comparative Example 2-1

Except that the relevant preparation parameters were adjusted according to Table 2, the rest was the same as Example 1-3.

The preparation parameters and electrical performance parameters of examples and comparative examples are shown in Tables 1 to 2.

TABLE 1

| | Carbon | | | | | | | | | 1 s DCR at | |
|---|---|---|---|---|---|---|---|---|---|---|---|
| | black particles | | | Carbon nanotubes | | | | | | 25° C. 20% | |
| | | B1 | | d2 | B2 | | B0 | | E0 | SOC | |
| | d1(nm) | (m²/g) | I_{D1}/I_{G1} | (nm) | (m²/g) | I_{D2}/I_{G2} | (m²/g) | I_{D}/I_{G} | (kJ/mol) | (mΩ) | R1(%) |
| Example 1-1 | 5 | 1500 | 1.10 | 8 | 270 | 0.90 | 680 | 1.2 | 49 | 51 | 40 |
| Example 1-2 | 10 | 1300 | 1.10 | 8 | 270 | 0.90 | 613 | 1.2 | 38 | 42 | 29 |
| Example 1-3 | 20 | 800 | 1.10 | 8 | 270 | 0.90 | 447 | 1.2 | 42 | 48 | 35 |
| Example 1-4 | 30 | 400 | 1.10 | 8 | 270 | 0.90 | 313 | 1.2 | 44 | 49 | 36 |
| Example 1-5 | 40 | 150 | 1.10 | 8 | 270 | 0.90 | 230 | 1.2 | 48 | 50 | 38 |
| Example 1-6 | 50 | 100 | 1.10 | 8 | 270 | 0.90 | 213 | 1.2 | 53 | 60 | 50 |
| Example 1-7 | 20 | 800 | 0.80 | 8 | 270 | 0.90 | 447 | 1.1 | 46 | 43 | 40 |
| Example 1-8 | 20 | 800 | 1.00 | 8 | 270 | 0.90 | 447 | 1.2 | 43 | 46 | 38 |
| Example 1-9 | 20 | 800 | 1.30 | 8 | 270 | 0.90 | 447 | 1.3 | 40 | 51 | 31 |
| Example 1-10 | 20 | 800 | 1.40 | 8 | 270 | 0.90 | 447 | 1.4 | 38 | 53 | 30 |
| Example 1-11 | 20 | 800 | 1.70 | 8 | 270 | 0.90 | 447 | 1.5 | 35 | 55 | 35 |
| Example 1-12 | 20 | 800 | 1.10 | 3 | 400 | 0.90 | 533 | 1.2 | 39 | 44 | 31 |
| Example 1-13 | 20 | 800 | 1.10 | 5 | 300 | 0.90 | 467 | 1.2 | 41 | 47 | 34 |
| Example 1-14 | 20 | 800 | 1.10 | 10 | 230 | 0.90 | 420 | 1.2 | 44 | 50 | 37 |
| Example 1-15 | 20 | 800 | 1.10 | 15 | 200 | 0.90 | 400 | 1.2 | 45 | 52 | 40 |
| Example 1-16 | 20 | 800 | 1.10 | 8 | 270 | 0.60 | 447 | 1.0 | 44 | 44 | 38 |
| Example 1-17 | 20 | 800 | 1.10 | 8 | 270 | 1.20 | 447 | 1.4 | 39 | 52 | 30 |
| Example 1-18 | 20 | 800 | 1.10 | 8 | 270 | 1.30 | 447 | 1.6 | 38 | 55 | 38 |
| Comparative | 60 | 50 | 1.10 | 20 | 150 | 0.90 | 117 | 1.2 | 70 | 70 | 70 |
| Example 1-1 | | | | | | | | | | | |
| Comparative | 3 | 2000 | 1.10 | 2.5 | 500 | 0.90 | 1700 | 1.2 | 22 | 65 | 75 |
| Example 1-2 | | | | | | | | | | | |
| Comparative | 20 | 1500 | 1.10 | 8 | 270 | 0.90 | 680 | 1.2 | 70 | 70 | 78 |
| Example 1-3 | | | | | | | | | | | |
| Comparative | 5 | 1500 | 1.70 | 8 | 270 | 0.90 | 680 | 1.6 | 20 | 45 | 74 |
| Example 1-4 | | | | | | | | | | | |
| Comparative | / | / | / | / | / | / | 500 | 1.2 | 80 | 100 | 85 |
| Example 1-5 | | | | | | | | | | | |

Note:
(1) In Table 1, “/” indicates no relevant preparation parameter.

TABLE 2

| | | | | | | | | Type of | | | | 1 s DCR | |
|---|---|---|---|---|---|---|---|---|---|---|---|---|---|
| | | Mass percentage of substance in | | | | | Type of | positive | | | | at 25° C. | |
| | | positive electrode material layer | | | | | positive | electrode | | | | 20% | |
| | B1 | W11 | W12 | | | | electrode | active | B0 | | E0 | SOC | R1 |
| | (m²/g) | (%) | (%) | W1(%) | W3(%) | W2(%) | binder | material | (m²/g) | I_{D}/I_{G} | (kJ/mol) | (mΩ) | (%) |
| Example 1-3 | 800 | 0.3 | 0.6 | 0.9 | 1.5 | 97.6 | PVDF | LCO | 447 | 1.2 | 42 | 48 | 35 |
| Example 2-1 | 1000 | 0.2 | 0.8 | 1.0 | 1.2 | 97.8 | PVDF | LCO | 416 | 1.2 | 44 | 52 | 43 |
| Example 2-2 | 200 | 0.5 | 0.4 | 0.9 | 1.5 | 97.6 | PVDF | LCO | 231 | 1.3 | 55 | 58 | 53 |
| Example 2-3 | 800 | 0.8 | 0.2 | 1.0 | 1.5 | 97.5 | PVDF | LCO | 694 | 1.4 | 35 | 40 | 26 |
| Example 2-4 | 1500 | 1.0 | 0.0 | 1.0 | 2.0 | 97.0 | PVDF | LCO | 1500 | 1.4 | 25 | 30 | 10 |
| Example 2-5 | 150 | 1.5 | 0.0 | 1.5 | 2.5 | 96.0 | PVDF | LCO | 150 | 1.4 | 61 | 56 | 58 |
| Example 2-6 | 150 | 0.2 | 1.5 | 1.7 | 2.5 | 95.8 | PVDF | LCO | 256 | 1.2 | 50 | 45 | 46 |
| Example 2-7 | 1500 | 0.2 | 0.1 | 0.3 | 0.5 | 99.2 | PVDF | LCO | 1090 | 1.3 | 65 | 60 | 60 |
| Example 2-8 | 800 | 0.3 | 0.6 | 0.9 | 1.5 | 97.6 | Polyacrylate | LCO | 447 | 1.2 | 65 | 60 | 60 |
| Example 2-9 | 800 | 0.3 | 0.6 | 0.9 | 1.5 | 97.6 | Polyethylene | LCO | 447 | 1.2 | 60 | 58 | 57 |
| Example 2- | 150 | 1.5 | 1.5 | 3.0 | 3.0 | 94.0 | PVDF | Lithium | 210 | 1.3 | 40 | 38 | 20 |
| 10 | | | | | | | | iron | | | | | |
| | | | | | | | | phosphate | | | | | |
| Example 2- | 800 | 0.6 | 0.7 | 1.3 | 1.8 | 96.9 | PVDF | NCM811 | 515 | 1.3 | 48 | 52 | 40 |
| 11 | | | | | | | | | | | | | |
| Comparative | 100 | 0.8 | 0.0 | 0.8 | 1.3 | 97.9 | PVDF | LCO | 100 | 1.4 | 70 | 75 | 78 |
| Example 2-1 | | | | | | | | | | | | | |

Note:
(1) In Table 2, taking Example 1-3 as an example, the type of positive electrode active material is “LCO”, meaning the positive electrode active material is lithium cobalt oxide (LiCoO₂), and other examples are analogous.

From Examples 1-1 to 1-18, Examples 2-1 to 2-11, Comparative Examples 1-1 to 1-5, and Comparative Example 2-1, it can be seen that when the type and specific surface area of the conductive agent and the activation energy of the positive electrode plate are within the ranges of this application, the prepared lithium-ion battery has lower 1s DCR at 25° C. 20% SOC and internal resistance growth rate after 800 cycles at 25° C., indicating that the internal resistance of the lithium-ion battery can be reduced. In Comparative Examples 1-1 and 1-2 and Comparative Example 2-1, the specific surface area of the conductive agent and the activation energy of the positive electrode plate are not within the ranges of this application, in Comparative Examples 1-3 and 1-4, the activation energy of the positive electrode plate is not within the range of this application, and in Comparative Example 1-5, the type of the conductive agent is not within the range of this application. The prepared lithium-ion battery has higher 1s DCR at 25° C. 20% SOC and internal resistance growth rate after 800 cycles at 25° C., indicating that the internal resistance of the lithium-ion battery is higher. In Comparative Example 1-2, the specific surface area of the conductive agent is too large, making processing of the positive electrode slurry difficult, and the conductive agent agglomerates, resulting in higher 1s DCR at 25° C. 20% SOC and internal resistance growth rate after 800 cycles at 25° C. of the lithium-ion battery, and larger internal resistance of the lithium-ion battery.

The average particle size and specific surface area of the carbon black particles usually affect the internal resistance of the lithium-ion battery. From Examples 1-1 to 1-6, it can be seen that by regulating the average particle size and specific surface area of the carbon black particles within the ranges of this application, the prepared lithium-ion battery has lower 1s DCR at 25° C. 20% SOC and internal resistance growth rate after 800 cycles at 25° C., indicating that the internal resistance of the lithium-ion battery can be reduced. In Examples 1-1 to 1-6, the specific surface area of the carbon black particles in Example 1-1 is relatively large, which will affect the dispersion of the carbon black particles to a certain extent, part of the carbon black may agglomerate, affecting the conductive network of the positive electrode material layer. As a result, the 1s DCR at 25° C. 20% SOC and the internal resistance growth rate after 800 cycles at 25° C. of the lithium-ion battery are relatively higher.

The value of I_{D1}/I_{G1} of the carbon black particles usually affects the internal resistance of the lithium-ion battery. From Example 1-3 and Examples 1-7 to 1-11, it can be seen that by regulating the value of I_{D1}/I_{G1} of the carbon black particles within the range of this application, the prepared lithium-ion battery has lower 1s DCR at 25° C. 20% SOC and internal resistance growth rate after 800 cycles at 25° C., indicating that the internal resistance of the lithium-ion battery can be reduced. In Example 1-3 and Examples 1-7 to 1-11, as the value of I_{D1}/I_{G1} of the carbon black particles increases, the internal resistance growth rate after 800 cycles at 25° C. first decreases and then increases. This is because as I_{D1}/I_{G1} of the carbon black particles increases, the surface defects of the carbon black particles increase, which is conducive to reducing the activation energy of the positive electrode plate and reducing the internal resistance growth rate after 800 cycles at 25° C. of the lithium-ion battery. However, when I_{D1}/I_{G1} of the carbon black particles is high, the activation energy of the positive electrode plate is reduced, and the defects of the conductive agent also increase, which can catalyze side reactions, thus increasing the internal resistance growth rate after 800 cycles at 25° C. of the lithium-ion battery.

The diameter and specific surface area of the carbon nanotubes usually affect the internal resistance of the lithium-ion battery. From Example 1-3 and Examples 1-12 to 1-15, it can be seen that by regulating the diameter and specific surface area of the carbon nanotubes within the ranges of this application, the prepared lithium-ion battery has lower 1s DCR at 25° C. 20% SOC and internal resistance growth rate after 800 cycles at 25° C., indicating that the internal resistance of the lithium-ion battery can be reduced. In Example 1-3 and Examples 1-12 to 1-15, the specific surface area of the carbon nanotubes in Example 1-12 is large, which will increase the viscosity of the positive electrode slurry, need to reduce the solid content of the positive electrode slurry, reduce the coating and drying efficiency, and increase the production cost.

The value of I_{D2}/I_{G2} of the carbon nanotubes usually affects the internal resistance of the lithium-ion battery. From Example 1-3 and Examples 1-16 to 1-18, it can be seen that by regulating the value of I_{D2}/I_{G2} of the carbon nanotubes within the range of this application, the prepared lithium-ion battery has lower 1s DCR at 25° C. 20% SOC and internal resistance growth rate after 800 cycles at 25° C., indicating that the internal resistance of the lithium-ion battery can be reduced.

The value of I_{D}/I_{G} of the conductive agent usually affects the internal resistance of the lithium-ion battery. From Examples 1-1 to 1-18, it can be seen that by regulating the value of I_{D}/I_{G} of the conductive agent within the range of this application, the prepared lithium-ion battery has lower 1s DCR at 25° C. 20% SOC and internal resistance growth rate after 800 cycles at 25° C., indicating that the internal resistance of the lithium-ion battery can be reduced.

The mass percentage of the conductive agent usually affects the internal resistance of the lithium-ion battery. From Example 1-3 and Examples 2-1 to 2-7, it can be seen that by regulating the mass percentage of the conductive agent within the range of this application, the prepared lithium-ion battery has lower 1s DCR at 25° C. 20% SOC and internal resistance growth rate after 800 cycles at 25° C., indicating that the internal resistance of the lithium-ion battery can be reduced.

From Examples 2-8 and 2-9, it can be seen that when the type of the positive electrode binder is within the range of this application, the prepared lithium-ion battery has lower 1s DCR at 25° C. 20% SOC and internal resistance growth rate after 800 cycles at 25° C., indicating that the internal resistance of the lithium-ion battery can be reduced.

From Examples 2-10 and 2-11, it can be seen that when the type of the positive electrode active material is within the range of this application, the prepared lithium-ion battery has lower 1s DCR at 25° C. 20% SOC and internal resistance growth rate after 800 cycles at 25° C., indicating that the internal resistance of the lithium-ion battery can be reduced.

It should be noted that in this document, relational terms such as first and second are only used to distinguish one entity or operation from another entity or operation, and do not necessarily require or imply any such actual relationship or order between these entities or operations. Moreover, the terms “include”, “comprise” or any other variants thereof are intended to cover non-exclusive inclusion, so that a process, method or article including a series of elements not only includes those elements, but also includes other elements not explicitly listed, or also includes elements inherent to such process, method or article.

The various embodiments in this specification are described in a related manner, and the same and similar parts between the various embodiments can be referred to each other, and each embodiment focuses on the differences from other embodiments.

The above are only preferred embodiments of this application and are not intended to limit this application. Any modifications, equivalent replacements, improvements, etc. made within the spirit and principles of this application should be included in the protection scope of this application.

1. A secondary battery, comprising a positive electrode plate, wherein the positive electrode plate comprises a positive electrode current collector and a positive electrode material layer provided on at least one surface of the positive electrode current collector, the positive electrode material layer comprises a conductive agent, the conductive agent comprises carbon black particles and/or carbon nanotubes, a specific surface area B0 of the conductive agent is 150 m²/g to 1500 m²/g, and an activation energy E0 of the positive electrode plate is 25 kJ/mol to 65 kJ/mol.

2. The secondary battery according to claim 1, wherein the specific surface area B0 of the conductive agent is 300 m²/g to 800 m²/g.

3. The secondary battery according to claim 1, wherein a Raman spectrum of the conductive agent has a first characteristic peak with a peak intensity of Ip in a range of 1300 cm⁻¹ to 1400 cm⁻¹, and a second characteristic peak with a peak intensity of I_{G} in a range of 1550 cm⁻¹ to 1650 cm⁻¹, wherein 1.0≤I_{D}/I_{G}≤1.5.

4. The secondary battery according to claim 1, wherein an average particle size d1 of the carbon black particles is 5 nm to 50 nm; and/or the conductive agent comprises the carbon black particles and the carbon nanotubes, and a specific surface area B1 of the carbon black particles is 100 m²/g to 150 m²/g.

5. The secondary battery according to claim 1, wherein an average particle size d1 of the carbon black particles is 10 nm to 40 nm; and/or a specific surface area B1 of the carbon black particles is 700 m²/g to 1400 m²/g.

6. The secondary battery according to claim 1, wherein a Raman spectrum of the carbon black particles has a third characteristic peak with a peak intensity of I_{D1} in a range of 1300 cm⁻¹ to 1400 cm⁻¹, and a fourth characteristic peak with a peak intensity of I_{G1} in a range of 1550 cm⁻¹ to 1650 cm⁻¹, wherein 0.8≤I_{D1}/I_{G1}≤1.7.

7. The secondary battery according to claim 1, wherein a diameter d2 of the carbon nanotubes is 3 nm to 15 nm.

8. The secondary battery according to claim 1, wherein a specific surface area B2 of the carbon nanotubes is 200 m²/g to 300 m²/g.

9. The secondary battery according to claim 1, wherein a Raman spectrum of the carbon nanotubes, has a fifth characteristic peak with a peak intensity of I_{D2} in a range of 1300 cm⁻¹ to 1400 cm⁻¹, and a sixth characteristic peak with a peak intensity of I_{G2} in a range of 1550 cm⁻¹ to 1650 cm⁻¹, wherein 0.6≤I_{D2}/I_{G2}≤1.3.

10. The secondary battery according to claim 1, wherein based on a mass of the positive electrode material layer, a mass percentage W1 of the conductive agent is 0.3% to 3.0%.

11. The secondary battery according to claim 1, wherein the conductive agent comprises the carbon black particles and the carbon nanotubes; and based on a mass of the positive electrode material layer, a mass percentage W11 of the carbon black particles is 0.2% to 1.5%, and a mass percentage W12 of the carbon nanotubes is greater than 0 to 1.5%.

12. An electronic device, comprising the secondary battery according to claim 1.

13. The electronic device according to claim 12, wherein the specific surface area B0 of the conductive agent is 300 m²/g to 800 m²/g.

14. The electronic device according to claim 12, wherein a Raman spectrum of the conductive agent has a first characteristic peak with a peak intensity of I_{D} in a range of 1300 cm⁻¹ to 1400 cm⁻¹, and a second characteristic peak with a peak intensity of I_{G} in a range of 1550 cm⁻¹ to 1650 cm⁻¹, wherein 1.0≤I_{D}/I_{G}≤1.5.

15. The electronic device according to claim 12, wherein an average particle size d1 of the carbon black particles is 5 nm to 50 nm; and/or the conductive agent comprises the carbon black particles and the carbon nanotubes, and a specific surface area B1 of the carbon black particles is 100 m²/g to 150 m²/g.

16. The electronic device according to claim 12, wherein an average particle size d1 of the carbon black particles is 10 nm to 40 nm; and/or a specific surface area B1 of the carbon black particles is 700 m²/g to 1400 m²/g.

17. The electronic device according to claim 12, wherein a Raman spectrum of the carbon black particles has a third characteristic peak with a peak intensity of I_{D}1 in a range of 1300 cm⁻¹ to 1400 cm⁻¹, and a fourth characteristic peak with a peak intensity of I_{G1} in a range of 1550 cm⁻¹ to 1650 cm⁻¹, wherein 0.8≤I_{D1}/I_{G1}≤1.7.

18. The electronic device according to claim 12, wherein a diameter d2 of the carbon nanotubes is 3 nm to 15 nm.

19. The electronic device according to claim 12, wherein a specific surface area B2 of the carbon nanotubes is 200 m²/g to 300 m²/g.

20. The electronic device according to claim 12, wherein a Raman spectrum of the carbon nanotubes has a fifth characteristic peak with a peak intensity of I_{D2} in a range of 1300 cm⁻¹ to 1400 cm⁻¹, and a sixth characteristic peak with a peak intensity of I_{G2} in a range of 1550 cm⁻¹ to 1650 cm⁻¹, wherein 0.6≤I_{D2}/I_{G2}≤1.3.
